(19) United States
(12) Patent Application Publication
(10) Pub. No.: US 2016/0002764 A1
(43) Pub. Date: Jan. 7, 2016

(54) THERMAL SPRAY POWDER FOR SLIDING SYSTEMS WHICH ARE SUBJECT TO HEAVY LOADS

(71) Applicant: H.C. Starck GmbH, Goslar (DE)

(72) Inventors: Benno GRIES, Wolfenbuettel (DE); Bernhard BRUENING, Bad Harzburg (DE)

(21) Appl. No.: 14/761,007

(22) PCT Filed: Jan. 23, 2014
(86) PCT No.: PCT/EP2014/051325

§ 371 Date: Jul. 15, 2015

Related U.S. Application Data
(60) Provisional application No. 61/756,476, filed on Jan. 25, 2013.

(30) Foreign Application Priority Data
Jan. 24, 2013 (DE) 10 2013 201 103.2

(51) Int. Cl. C23C 4/10; C01B 21/06; C09D 1/00; C22C 29/06

(52) U.S. Cl. CPC C23C 4/10; C22C 29/06; C01B 21/062; C09D 1/00

(57) ABSTRACT

A process for producing a chromium nitride-containing spraying powder includes providing an alloy powder comprising at least 10 wt.-% of chromium, and at least 10 wt.-% of at least one element selected from transition groups IIIA to IIB of the Periodic Table of Elements and B, Al, Si, Ti, Ga, C, Ge, P and S. The alloy powder is nitrided in the presence of nitrogen so as to form at least one of CrN and Cr₂N.

### CROSS REFERENCE TO PRIOR APPLICATIONS

This application is a U.S. National Phase application under 35 U.S.C. §371 of International Application No. PCT/EP2014/051325, filed on Jan. 23, 2014 and which claims benefit to German Patent Application No. 10 2013 201 103.2, filed on Jan. 24, 2013, and to U.S. Provisional Patent Application No. 61/756,476, filed on Jan. 25, 2013. The International Application was published in German on Jul. 31, 2014 as WO 2014/114715 A1 under PCT Article 21(2).

### FIELD

The present invention relates to a process for producing chromium nitride-containing spraying powder, a chromium nitride-containing spraying powder which is obtainable by such a process, and also a process for producing a surface-coated component by thermal coating of the component with the powder. The present invention further relates to a coated component obtainable by such a coating process, and also the use of the powder for the surface coating of components, in particular components in piston machines, for example, piston rings or other, tribologically stressed components such as hydraulic cylinders.

### BACKGROUND

Tribologically stressed parts of this type are provided with coatings in order to improve the tribological and wear properties. Coatings are characterized, in a manner analogous to massive materials, by various properties which can be determined empirically. These include, for example, hardness, wear resistance, and corrosion resistance in various environments or workability. Customary spraying processes are, for example, thermal spraying, laser cladding, and physical or chemical vapor deposition (PVD, CVD).

In many applications, however, the frictional behavior of coatings relative to a second friction partner plays a particular role. Examples are coated piston rods which run in a guide sheath made of steel or cast iron. The behavior of the friction pairing “coating/friction partner” is of great importance, for example, in (internal) combustion engines where coated piston rings run in a bushing made of, for example, gray cast iron or AlSi alloys. CrN has been found to be particularly useful in such applications. Coatings composed of or containing CrN are therefore widely applied by PVD (physical vapor deposition) to piston rings for (internal) combustion engines, piston compressors, and similar piston machines, but also to extruder screws and similar components, for example, for plastics processing or nonferrous metal working. Such layers allow good running performance or operating lives (lifetimes) with minimal wear and have become established, for example, in the passenger car sector. A disadvantage is, however, a high capital outlay for plant engineering, which is economical only in the case of large quantities and components having small dimensions. It was hitherto not possible to apply CrN economically by means of PVD for components having relatively large dimensions or thicker layers. Stresses due to different coefficients of thermal expansion of substrate to be coated and layer material also occur in PVD layers having increasing layer thickness. Such stresses lead to crack formation through to detachment of the layer. As a result, there is insufficient wear reserve for many uses in highly stressed friction pairings due to an insufficient layer thickness.

Thermal spraying is a possible alternative to PVD for producing coatings. Coatings produced by thermal spraying can have a layer thickness up to several 100 μm.

For the purposes of the present invention, thermal spraying is the application of a material to a (usually) metallic surface in which the material is, before impingement on the surface, conveyed into an energy source, usually a burner flame or plasma flame, and melts completely or partly due to the thermal energy of the energy source, and also experiences acceleration in the direction of the substrate surface as a result of the kinetic energy of the gas stream. When powders are applied directly to the substrate by means of a thermal spraying process, these are referred to as thermal spraying powders.

Customary thermal spraying processes include, for example, high-energy flame spraying using air or oxygen, plasma spraying, or electric arc spraying of powders or powder-filled wires. Pulverulent particles are here introduced into a combustion flame or plasma flame which is directed at the (usually metallic) substrate which is to be coated. The particles thereby melt completely or partly in the flame, impinge on the substrate, solidify there, and form the coating in the form of solidified flat particles (known as “splats”). The processes mentioned makes it possible to apply coatings having a thickness of from about 50 μm to about 2000 μm, and allow optimal layers to be developed for particular uses by targeted selection of process and powder.

Coatings produced by such processes, known as thick layers, often consist of one or more usually ceramic and/or metallic components. The metallic component is here able to dissipate stresses in the layer by elastic deformation or plastic flow, while the ceramic hard phase gives optimal wear behavior of the layer. Good layer quality is characterized by a largely homogeneous distribution of the individual components and by a low porosity. There are additional requirements defined by the respective use, for example, in respect of wear resistance and/or corrosion resistance.

Powders for thermal coating, hereinafter referred to as “spraying powders” can, depending on the production process, be present in various forms. Customary forms are, for example, “agglomerated/sintered” or “densely sintered”, “melted”, “gas-atomized, or water-atomized”. The typical internal structure of such forms are described in DIN EN 1274.

Spraying powders having differing natures can also be mixed. Such “blends”, however, lead to an inhomogeneous distribution of the individual components in the layer which is disadvantageous for many uses. Demixing (segregation) can also occur during powder transport and during spraying, and the composition of the layer can therefore differ locally from the composition of the powder mixture.

The use of agglomerated and subsequently intrinsically sintered (sintered together in itself) spraying powders (“agglomerated/sintered spraying powders”) composed of different individual components enables the layer homogeneity to be substantially improved since the use of fine individual components enables optimum distribution of the individual constituents in the sintered pellets and in the sprayed layer to be achieved. Agglomeration is usually effected by spray drying an aqueous suspension of the individual components. Selection of the process parameters during agglomeration makes it possible to set the grain size distribution in a targeted manner and adapt it to the spraying system. The impingement efficiency can be substantially improved by means of optimal spraying parameters.

Agglomerated/sintered spraying powders or sintered spraying powders offer the additional advantage of setting the composition of the layer in a targeted manner by selection of the individual components. Agglomerated/sintered spraying powders based on, for example, WC—Co(—Cr) or Cr₃C₂—NiCr, are widespread.

Compared to agglomerated/sintered spraying powders, atomized powders have a more uniform composition than agglomerated/sintered spraying powders since they are formed from a homogeneous melt. Atomized powders are produced by making available the components in nonoxidic form (these can, for example, be metals, ferrous alloys, graphite, master alloys, and others), melting them together, and then atomizing the melt to produce droplets. The droplets cool during flight through a protective gas atmosphere or are solidified in water and are subsequently collected. While water-atomized powders have a splat-like morphology due to their sudden cooling, gas-atomized powders typically have a good spherical shape.

As in the case of agglomeration, selection of the process parameters during atomization likewise makes it possible to set the grain size distribution in a targeted manner. Owing to the spherical particle shape of gas-atomized alloys, these are often free-flowing and can be transported and processed advantageously. Customary spraying processes for atomized powders are, for example, plasma spraying and high-energy flame spraying.

Compared to agglomerated/sintered spraying powders, individual particles of atomized powders barely have any internal porosity. Layers produced from atomized spraying powders are more homogeneous and have a lower porosity than comparable layers produced from agglomerated/sintered spraying powders. Since atomized powders are obtained from a homogeneous melt, the ability to produce composite powders composed of a plurality of components is thereby greatly restricted.

Thermal spraying layers based on Cr₃C₂, or based on Mo₂C in combination with metals and alloys such as Ni, Mo or NiCr, or spontaneously flowing alloys such as NiCrBSi, or combinations thereof, are widespread in the prior art within tribological systems, for example, within hydraulic cylinders or piston machines. Agglomerated/sintered spraying powders are usually used, but blends are occasionally also used.

EP 0960954 B1 describes a powder which consists essentially of Cr, Ni and C which was produced by gas atomization in combination with subsequent heat treatment to precipitate carbides.

DE 10 2008 064 190 A1 describes a process for producing a water-atomized Fe-based powder which is suitable for thermal spraying and which has a carbon content of 4-9% and also, inter alia, Si as further constituent. Such a powder contains fine carbide and silicide precipitates as a hard material constituent, but nitrogen only as constituent of the alloy, and not as hard material constituent. A further disadvantage is that the thermal sprayability is brought about by means of a subsequent mechanical or thermal treatment in which the chromium nitrides are degraded. Further atomized powders having incorporated hard material constituents and, in particular, nitrides as a hard material phase, are not, however, described.

Owing to its molecular structure and the associated pronounced chemical inertness, CrN has excellent resistance to frictional wear and also microwelding. This also applies in corrosive environments and in the presence of lubricants. For this reason, forming tools, for example, composed of cold working steels or, for example, tools for plastics processing, are often provided with a thin layer of CrN or Cr₂N. Such layers applied by PVD, known as thin layers, display excellent wear resistance, for example, in the working of nonferrous metals, and often allow minimal quantity lubrication or a change to aqueous emulsions as lubricating medium. Thin layers applied by PVD usually have a typical thickness of only about 2-10 μm. With increasing layer thickness, the residual compressive stresses in the layer also increase. When the residual compressive stresses in the layer approach the adhesive strength of the layer, detachment of the layer (delamination) or spalling of the layer can occur. Residual stresses can be reduced by application of a plurality of structured sublayers, by which means layers of >10 μm can be applied with sufficient adhesive strength via PVD.

EP 1774053 B1 describes a process for producing a coating on a piston ring, which coating allows application of relatively thick CrN layers by means of a modified PVD process. EP 1774053 B1 states that this makes it possible to produce layer thicknesses in the range from 10 to 80 μm.

Thin layers have also been described into which fine dispersoids consisting of nickel have been introduced so as to dissipate residual stresses in the layer by elastic deformation or plastic flow and thus decrease the hardness of the layer in a targeted manner (A Plasma assisted MOCVD Process for synthesis of CrN/Ni Composite Coatings, A. Dasgupta, P. Kuppusami, IGCAR).

Ni—CrN(Cr₂N) PVD composite layers have further been described which are used, inter alia, as an alternative to electrolytically deposited hard chromium layers.

A disadvantage of PVD processes is the restriction to substrates having limited dimensions since the PVD coating process takes place in a closed oven. The process is also very time-consuming, in particular in the case of structured or multilayer coatings. The production and repair of layers via PVD is therefore very costly. In-situ repair of PVD layers is also usually not possible since a PVD layer can, in contrast to thermal spraying layers, only be freshly built up in its entirety in the case of a repair, which drastically increases the outage times and in many cases cannot be carried out economically.

In practice, the low thickness of the PVD layers is sometimes particularly disadvantageous, which can mean that the wear reserve is not sufficient for relatively long operating lives.

To overcome these disadvantages, a thermally sprayed layer based on chromium nitrides would be advantageous. The basis for such a layer would be a spraying powder which contains chromium nitrides and a metallic fraction as ductile component to dissipitate stresses in the layer and which can at the same time be processed to give high-quality layers.

Such spraying powders are not available according to the present prior art. DE 10 2008 056 720 B3 describes a coated sliding element which serves as a piston ring in an (internal) combustion engine. The coating concerned is based on CrN-containing spraying powders, the production process for which is not disclosed. The state of the art for piston ring coatings is a blend of one or more ceramic components and one or more metallic components (DE 69605270 T2).

The sliding layer described in DE 10 2008 056 720 B3 has a nominal composition of from 10 to 30% of Ni, from 0.1 to 5% of carbon, from 10 to 20% of nitrogen, and from 40 to 79.9% of chromium. The spraying powder described in the working example has a nominal composition of 60% of CrN, 10% of Cr₃C₂, 25% of Ni, and 5% of Cr. The homogeneous distribution of the carbides (i.e., the 10% of Cr₃C₂ present in the spraying powder) in the sprayed layer is described. The size and distribution of the CrN is not described.

### SUMMARY

An aspect of the present invention is to solve the abovementioned problems of the prior art. An aspect of the present invention is in particular to provide a spraying powder which allows the production of layers having a high density and layer homogeneity, and which has good processing properties as a thermal spraying powder, as well as chromium nitrides as a hard material phase.

In an embodiment, the present invention provides a process for producing a chromium nitride-containing spraying powder which includes providing an alloy powder comprising at least 10 wt.-% of chromium, and at least 10 wt.-% of at least one element selected from transition groups IIIA to IIB of the Periodic Table of Elements and B, Al, Si, Ti, Ga, C, Ge, P and S. The alloy powder is nitrided in the presence of nitrogen so as to form at least one of CrN and Cr₂N.

### BRIEF DESCRIPTION OF THE DRAWINGS

The present invention is described in greater detail below on the basis of embodiments and of the figures in which:

FIG. 1 shows an electron micrograph of the powder obtained as per Example 1;

FIG. 2 shows an electron micrograph of a powder obtained as per Example 2:

FIG. 3 shows an electron micrograph of a powder obtained as per Example 3;

FIG. 4 shows an electron micrograph of a powder obtained as per Example 4;

FIG. 5 shows an electron micrograph of a powder obtained as per Example 5;

FIG. 6 shows an electron micrograph of a powder obtained as per Example 6.

FIG. 7 shows an electron micrograph of a powder obtained as per Example 7; and

FIG. 8 shows that the non-nitrided powders have no hard material precipitates of chromium nitrides.

### DETAILED DESCRIPTION

In an embodiment, the present invention provides a process for producing chromium nitride-containing spraying powder, which comprises the following steps:

a) production or provision of an alloy powder comprising,
i) at least 10% by weight of chromium, and
ii) at least 10% by weight of one or more further elements (A) selected from transition groups IIIA to IIB of the Periodic Table and also B, Si, Ti, Ga, C, Ge, P and S, and

b) nitriding of the powder in the presence of nitrogen with formation of CrN and/or Cr₂N.

In an embodiment of the present invention, the process comprises the following steps (where the steps a-1) and a-2) are substeps of step a) above):

a-1) production of a melt comprising,
i) at least 10% by weight of chromium, and
ii) at least 10% by weight of one or more further elements (A) selected from transition groups IIIA to IIB of the Periodic Table and also B, Si, Ti, Ga, C, Ge, P and S,

a-2) atomization of the melt produced in step a-1) to form an alloy powder, and

b) nitriding of the powder in the presence of nitrogen with formation of CrN and/or Cr₂N.

In an embodiment of the present invention, the alloy powder and the melt from which the alloy powder is produced by atomization can, for example, comprise at least 10% by weight of chromium and at least 10% by weight of one or more elements (A) selected from transition groups IIIA to IIB of the Periodic Table (IUPAC system, corresponding to CAS system IIIB to IIB) and aluminum.

The proportion of chromium in the alloy powder is important especially because a reaction of the chromium present in the alloy powder to form CrN and/or Cr₂N takes place in the subsequent nitriding step b).

In an embodiment of the present invention, the alloy powder can, for example, comprise chromium in an amount of 30-95% by weight, for example, 40-90% by weight, for example, 45-75% by weight, in each case based on the total weight of the alloy powder.

In an embodiment of the present invention, the remaining metals of the alloy powder (i.e., all metals apart from chromium) or the element(s) (A) can, for example, be present in an amount of 15-70% by weight, for example, 20-60% by weight, and for example, 25-55% by weight, in each case based on the total weight of the alloy powder.

In an embodiment of the present invention, the element(s) (A) of the alloy powder can, for example, be selected from among a cobalt base alloy, or a nickel base alloy, or iron base alloys, where the base alloy optionally contains one or more constituents selected from the group consisting of Si, Mo, Ti, Ta, Nb, V, S, C, P, Al, B, Y, W, Cu, Zn and Mn.

The further elements (A), in particular the remaining metals (i.e., all metals apart from chromium) of the alloy powder can, for example, be present in an amount of 15-70% by weight, for example, 20-60% by weight, and for example, 25-55% by weight, in each case based on the total weight of the alloy powder.

In an embodiment of the present invention, the weight ratio of chromium to the element(s) (A), in particular, to the remaining metals, can, for example, be from 1:9 to 9:1, for example, from 2:8 to 8:2, for example, from 3:7 to 7:3 and, for example, from 2:3 to 3:2.

In an embodiment of the present invention, the alloy powder can, for example, comprise one or more element(s) selected from the group consisting of Si, V, Mo, Ti, Ta, Nb, Al, B, Y, W, Cu, Zn and Mn in an amount of up to 20% by weight, for example, from 0.1 to 15% by weight, for example, from 0.2 to 10% by weight, for example, from 0.5 to 5% by weight, in each case based on the total weight of the alloy powder.

In an embodiment of the present invention, the alloy constituents from which the alloy powder is produced in process step a) can, for example, be present at least partly in elemental form or as ferrous alloy (ferro alloy).

The elements (A) serve essentially as a metal matrix (binder metal) for the chromium nitrides which are obtained by nitriding of the alloy powder and act as hard materials.

In an embodiment of the present invention, the alloy powder can, for example, comprise a cobalt base alloy, or a nickel base alloy, or an iron base alloy. The base alloy can contain one or more constituents selected from the group consisting of Si, Mo, Ti, Ta, V, S, C, P, Al, B, Y, W, Cu, Zn and Mn.

Depending on the nitriding conditions selected, one or more metals of the alloy powder apart from chromium may be nitrided.

In an embodiment of the process of the present invention, the alloy powder can, for example, comprise a nickel-chromium alloy powder, a cobalt-chromium alloy powder, or a iron-chromium alloy powder.

The production of the alloy powder can be carried out in various ways with which a person skilled in the art will be familiar. The alloy powder can, for example, be obtained by comminution of cast pieces.

In an embodiment of the present invention, the alloy powder can, for example, be produced by a melt comprising:
i) at least 10% by weight of chromium; and
ii) at least 10% by weight of one or more further metals (A) selected from transition groups IIIA to IIB of the Periodic Table, and also B, Al, Si, Ti, Ga, C, Ge, P and S, and subsequent atomization of the melt produced to form an alloy powder.

The alloy powders produced by means of atomization lead to round and thus readily flowing powders having a high apparent density. During atomization, the melt is broken up into tiny droplets. The melt can be broken up during atomization via a gas jet or water jet. Atomization of the melt can, for example, be preformed using a gas jet; the gas here comprises essentially protective gases, for example, essentially nitrogen or argon. The powders produced in this way thus have extremely low level of impurities.

An inexpensive alternative for producing the alloy powders is water atomization. The gaseous atomization medium, which is used in large amounts and is either lost or must be worked up in a complicated manner, is here replaced by inexpensive water. This makes a continuous mode of operation possible since evacuation and rinsing processes are dispensed with. Water atomization is thus an extremely inexpensive manufacturing process which is advantageous for the production of powders whose cost structure is determined more by processing and personnel costs than by materials costs.

In an embodiment of the present invention, the alloy constituents from which the melt is produced in process step a) can, for example, be at least partly present in elemental form or as a ferrous alloy.

In an embodiment of the present invention, atomization can, for example, be effected by a water jet, with the atomization angle a being in the range from 8° to 15°, and the atomization pressure, for example, being 50-400 bar, and the water temperature T, for example, being in the range from 10 to 50° C., for example, from 15 to 45° C. The setting of these parameters provides that the droplets of the melt solidify slowly so as to give a round particle shape. The water is also decomposed into its constituents to a lesser degree as a result of the slow cooling so that a smaller amount of oxides is attached to the powders.

The melt can, for example, have a temperature which is 20-250° C. above the melting point of the alloy.

In an embodiment of the present invention, atomization can, for example, be carried out in a protective gas atmosphere which comprises, in particular, argon and/or nitrogen, and in which the oxygen content is below 1% by volume, for example, below 0.1% by volume, based on the total volume of the protective gas.

The alloy powder produced or provided in step a) of the process of the present invention is nitrided in the presence of nitrogen with formation of CrN and/or Cr₂N in the subsequent step b).

Nitriding is diffusion-controlled and can be influenced by the process parameters, in particular, by pressure, temperature, and hold time, during the heat treatment. To form the chromium nitride precipitates after the solubility limit of nitrogen has been exceeded, it is necessary for nitrogen to diffuse into the interior of the particles. To form a covering layer, it is necessary for Cr to diffuse outward and nitrogen at the same time to diffuse into the interior of the particles. The diffusion coefficient of Cr in the particle is dependent exclusively on the temperature, while the diffusion coefficient of N in the particle depends both on the temperature and on the nitrogen partial pressure. The thickness of the covering layer can thus be set via the temperature.

Increasing the nitrogen partial pressure thermodynamically favors the formation of CrN so that the proportion of CrN predominates over Cr₂N. The nature of the precipitates can be controlled via the hold time. At a longer hold time, the small precipitates disappear with simultaneous growth of the remaining precipitates.

The nitriding of the alloy powder can, for example, be carried out in a gas atmosphere containing nitrogen with a partial pressure of greater than 1 bar. Nitriding can, for example, be carried out as solid-state nitriding, with nitrogen partial pressure and temperature being selected so that formation of or an increase in the amount and, if already present, stabilization of chromium nitrides, occurs as a result of nitrogen uptake during nitriding. There is thus no loss of chemically bound nitrogen during nitriding of the alloy powder, but rather an increase in the chemically bound nitrogen in the process of the present invention.

The presence of nitrogen gases in the gas atmosphere during nitriding is important to the process of the present invention. In an embodiment, nitriding can, for example, occur in a nitrogen-containing gas atmosphere which comprises more than 80% by volume, for example, more than 90% by volume, for example, more than 98% by volume, of nitrogen, in each case based on the total gas atmosphere.

The presence of oxygen is disadvantageous in the process step of nitriding. The presence of oxygen leads to formation of oxides which adversely affect the property profile of the spraying powder. In an embodiment of the process of the present invention, nitriding can, for example, be carried out in a nitrogen-containing gas atmosphere which comprises less than 1% by volume, for example, less than 0.5% by volume, for example, less than 0.05% by volume, and, for example, less than 0.01% by volume, of oxygen, in each case based on the total gas atmosphere.

It has also been found that the pressure of the gas atmosphere during nitriding, in particular during solid-state nitriding, can have a considerable influence on the formation of CrN and/or Cr₂N. The pressure of the gas atmosphere can, for example, be above 1 bar, for example, above 1.5 bar.

Particularly good results can be achieved when nitriding is carried out at a nitrogen partial pressure above 6 bar, for example, in the range of from 7 to 100 bar, for example, 8-15 bar, and, for example, 9-20 bar.

The higher the nitriding temperature, the higher the selection of the required minimum value for the nitrogen partial pressure should be selected.

The nitriding, in particular the solid-state nitriding, can, for example, be carried out at a temperature above 1000° C., for example, in the range from 1050 to 1500° C., for example, from 1100° C. to 1350° C. and, for example, from 1100° C. to 1250° C.

The nitriding, in particular the solid-state nitriding, is usually carried out over a period of at least 1 hour, for example, at least 2 hours, for example, at least 2.5 hours, and, for example, in the range from 3 to 48 hours.

In an embodiment of the present process of the present invention, the major part of the sintering bridges which may have been produced during nitriding between the powder particles formed by atomization can, for example, be broken after nitriding.

The chromium nitride-containing spraying powders obtainable by the process of the present invention have excellent properties. The use of the spraying powders in thermal spraying processes makes it possible to form substantially thicker layers than in comparable PVD processes.

The present invention further provides a chromium nitride-containing spraying powder obtainable by the process of the present invention for producing chromium nitride-containing spraying powder.

The chromium nitride-containing spraying powder of the present invention contains CrN and/or Cr₂N as hard materials.

These hard materials are usually present as disperse hard material precipitates. The hard material precipitates are usually dispersed (disperged) in the particles and are surrounded by the metallic matrix, in particular of the further elements (A).

The present invention further provides a chromium nitride-containing spraying powder, for example, obtainable by the production process of the present invention, which has chromium nitride precipitates having an average diameter of 0.1-20 μm, for example, 0.2-10 μm, and, for example, 0.4-6 μm (e.g., determined electrooptically as number average by image analysis of (electron) micrographs, for example, as a Jeffries diameter).

The spraying powder of the present invention contains chromium nitride, with CrN, for example, being present in an amount of 70% by weight, for example, at least 75% by weight, for example, at least 78% by weight, and, for example, at least 80% by weight, in each case based on the total weight of chromium nitride in the sintered spraying powder.

In an embodiment of the present invention, the spraying powder of the present invention is essentially free of carbides and/or borides. For the purposes of the present invention, essentially free means that precipitates of carbides and borides are smaller than 1 μm and are present, for example, in amounts of less than 0.5% by weight, based on the total weight of the hard materials.

In an embodiment of the present invention, the spraying powder of the present invention has dispersed chromium nitride precipitates.

As an alternative or in addition, the spraying powder of the present invention is surrounded by a covering layer of chromium nitrides which can, for example, have an average layer thickness of 1-8 μm.

In an embodiment of the present invention, the spraying powder of the present invention can, for example, comprise 50-80% by weight, for example, 55-75% by weight, of chromium nitrides, where the proportion by weight is based on the total weight of the powder.

In an embodiment of the present invention, the spraying powder of the present invention can, for example, comprise boron and/or sulfur, for example, in an amount of up to 1% by weight.

The spraying powder of the present invention can also be a constituent of a blend of various spraying powders.

The present invention therefore further provides a spraying powder blend comprising a spraying powder according to the present invention. The spraying powder blend can, for example, comprise one or more spraying powders which is/are different from the spraying powder of the present invention.

The chromium nitride-containing spraying powders of the present invention and also the spraying powder blends of the present invention are particularly suitable for the surface coating of components, for example, friction surfaces. The present invention therefore further provides a process for producing a surface-coated component by coating a component via a thermal spraying of a spraying powder according to the present invention or a spraying powder blend according to the present invention.

Thermal spraying can, for example, be carried out via a high-speed flame spraying or plasma spraying. The components which can be obtained by the coating process have extremely good friction properties. The spraying process also enables the component to be provided with a thicker wear layer compared to conventional layers produced by the PVD process.

The present invention therefore further provides a coated component obtainable by the coating process of the present invention. The coated component can, for example, have a wear layer which has been obtained by thermal spraying and a thickness of at least 15 μm, for example, at least 50 μm, for example, at least 100 μm, for example, at least 200 μm, and, for example, at least 250 μm.

The coated components can, for example, be piston rings or components in (internal) combustion engines, piston compressors or piston machines or other tribologically stressed components.

In an embodiment of the present invention, the coated components can, for example, be forming tools, or tools for plastics processing, or nonferrous metal working.

The present invention also provides for the use of the spraying powder of the present invention or of the spraying powder blend of the present invention for the surface coating of components, in particular piston rings or components in (internal) combustion engines, piston compressors, or piston machines, or other, tribologically stressed components.

The spraying powder of the present invention can in particular be used for surface coating by means of thermal spraying, in particular high-speed flame spraying or plasma spraying.

The following examples illustrate the present invention without restricting the present invention thereto:

### EXAMPLE 1

### According to the Present Invention

A powder having the following composition in % by weight: 8.86% of N, 43.9% of Ni, 0.41% of C, 0.25% of O, was obtained from an atomized alloy which is commercially available (from CuLox Technologies, alloy Ni—Cr 50/50) and consists of about 50% by weight of Ni and about 50% by weight of Cr by nitriding at a nitrogen partial pressure of 7 bar in a nitrogen gas atmosphere containing less than 0.001% by volume of oxygen at 1160° C. for 3 hours.

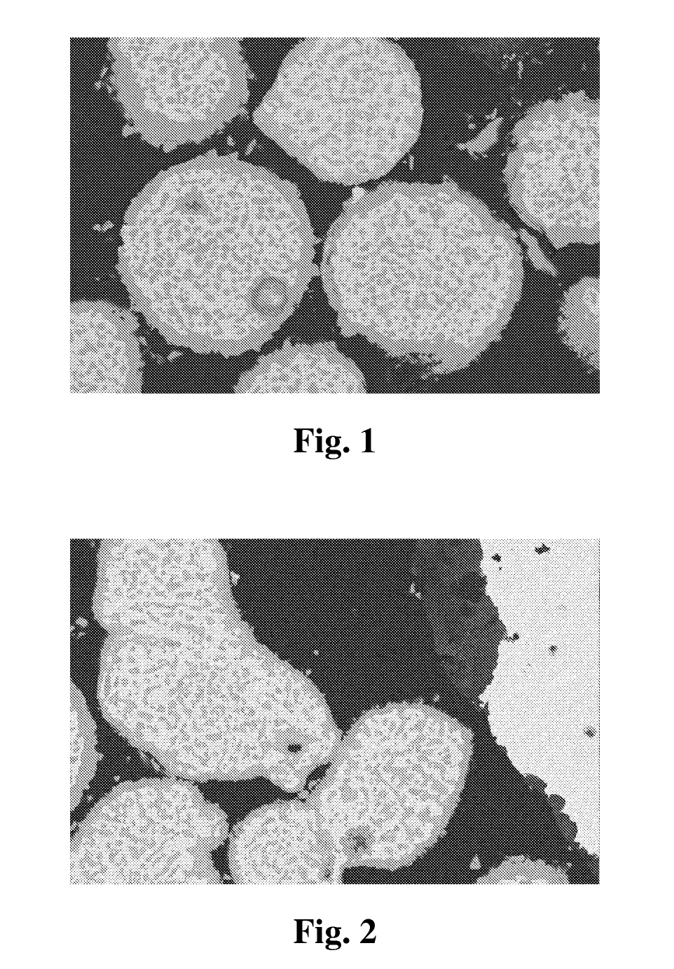

FIG. 1 shows an electron micrograph of the powder obtained as per Example 1.

### EXAMPLE 2

### According to the Present Invention

A powder having the following composition in % by weight: 9.45% of N, 43.3% of Ni, 0.43% of C, 0.39% of O was obtained from an atomized alloy which is commercially available (from CuLox Technologies, alloy Ni—Cr 50/50) and consists of about 50% by weight of Ni and about 50% by weight of Cr by nitriding at a nitrogen partial pressure of 11 bar in a nitrogen gas atmosphere containing less than 0.001% by volume of oxygen at 1160° C. for 3 hours.

FIG. 2 shows an electron micrograph of a powder obtained as per Example 2.

### EXAMPLE 3

### According to the Present Invention

A powder having the following composition in % by weight: 6.61% of N, 44.1% of Ni, 1.59% of C, 1.01% of 0 was obtained from an atomized alloy which is commercially available (from CuLox Technologies, alloy Ni—Cr 50/50) and consists of about 50% by weight of Ni and about 50% by weight of Cr by nitriding at a nitrogen partial pressure of 15 bar in a nitrogen gas atmosphere containing less than 0.001% by volume of oxygen at 1160° C. for 3 hours.

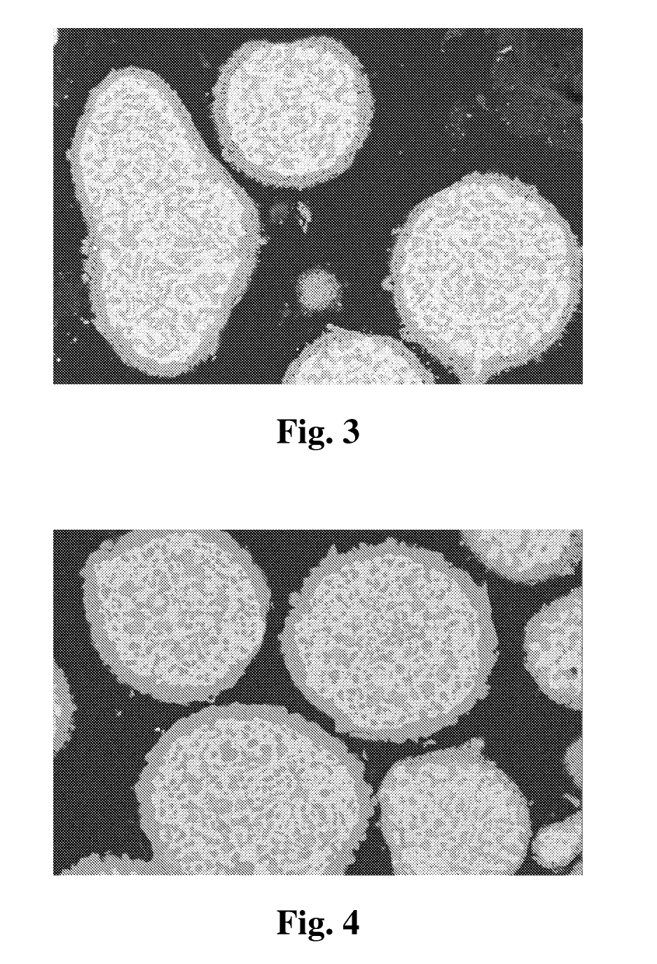

FIG. 3 shows an electron micrograph of a powder obtained as per Example 3.

### EXAMPLE 4

### According to the Present Invention

A powder having the following composition in % by weight: 7.32% of N, 44.8% of Ni, 0.63% of C, 0.37% of O was obtained from an atomized alloy which is commercially available (from CuLox Technologies, alloy Ni—Cr 50/50) and consists of about 50% by weight of Ni and about 50% by weight of Cr by nitriding at a nitrogen partial pressure of 7 bar in a nitrogen gas atmosphere containing less than 0.001% by volume of oxygen at 1200° C. for 3 hours.

FIG. 4 shows an electron micrograph of a powder obtained as per Example 4.

### EXAMPLE 5

### According to the Present Invention

A powder having the following composition in % by weight: 9.42% of N, 44.4% of Ni, 0.22% of C, 0.37% of 0 was obtained from an atomized alloy which is commercially available (from CuLox Technologies, alloy Ni—Cr 50/50) and consists of about 50% by weight of Ni and about 50% by weight of Cr by nitriding at a nitrogen partial pressure of 11 bar in a nitrogen gas atmosphere containing less than 0.001% by volume of oxygen at 1200° C. for 3 hours.

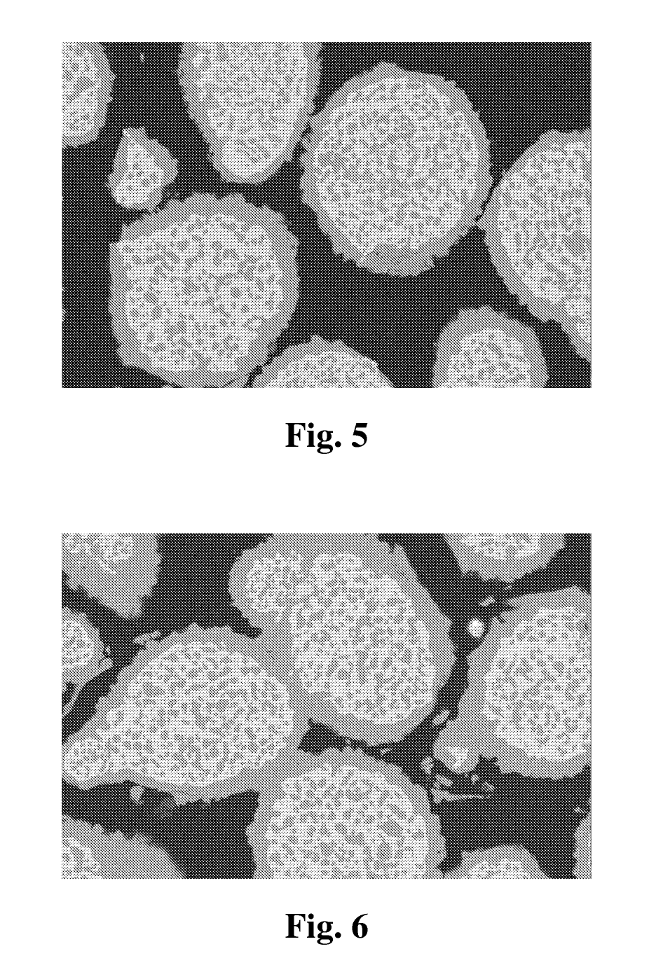

FIG. 5 shows an electron micrograph of a powder obtained as per Example 5.

### EXAMPLE 6

### According to the Present Invention

A powder having the following composition in % by weight: 10.3% of N, 43.1% of Ni, 0.17% of C, 0.29% of 0 was obtained from an atomized alloy which is commercially available (from CuLox Technologies, alloy Ni—Cr 50/50) and consists of about 50% by weight of Ni and about 50% by weight of Cr by nitriding at a nitrogen partial pressure of 15 bar in a nitrogen gas atmosphere containing less than 0.001% by volume of oxygen at 1200° C. for 3 hours.

FIG. 6 shows an electron micrograph of a powder obtained as per Example 6.

### EXAMPLE 7

### According to the Present Invention

A powder having the following composition in % by weight: 10.49% of N, 42.16% of Co, 0.19% of C, 0.27% of 0 was obtained from an atomized alloy consisting of about 45% by weight of Co and about 55% by weight of Cr by nitriding at a nitrogen partial pressure of 11 bar in a nitrogen gas atmosphere containing less than 0.001% by volume of oxygen at 1160° C. for 3 hours.

FIG. 7 shows an electron micrograph of a powder obtained as per Example 7.

### EXAMPLE 8

### Not According to the Present Invention

Atomized alloy powder which was the basis of examples 1 to 6.

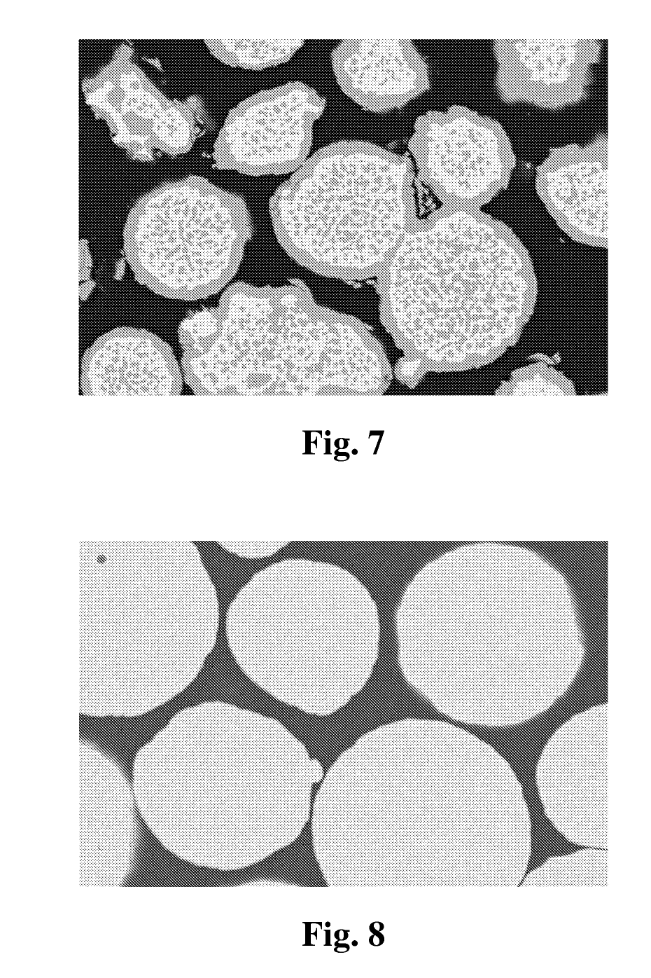

It can be seen from FIG. 8 that the non-nitrided powders have no hard material precipitates of chromium nitrides.

The powders according to the present invention are characterized by excellent processing properties. Owing to their largely spherical morphology, the powders according to the present invention are free-flowing; caking in the spray gun is also avoided as a result of the outer shell of CrN. Owing to the largely pore-free morphology of the powders, dense layers can also be sprayed, which effectively prevents substrate corrosion.

The present invention is not limited to embodiments described herein; reference should be had to the appended claims.

What is claimed is:

1-32. (canceled)

33. A process for producing a chromium nitride-containing spraying powder, the process comprising:
providing an alloy powder comprising,
at least 10 wt.-% of chromium, and at least 10 wt.-% of at least one element selected from,
transition groups IIIA to IIB of the Periodic Table of Elements, and
B, Al, Si, Ti, Ga, C, Ge, P and S; and
nitriding the alloy powder in the presence of nitrogen so as to form at least one of CrN and Cr₂N.

34. The process as recited in claim 33, wherein the nitriding is preformed at a nitrogen partial pressure of >1 bar.

35. The process as recited in claim 33, wherein the nitriding is performed at a nitrogen partial pressure in a range of from 7 to 100 bar.

36. The process as recited in claim 33, wherein the nitriding is performed in a nitrogen-containing gas atmosphere comprising less <1% by volume of oxygen, based on a total gas atmosphere.

37. The process as recited in claim 33, wherein the nitriding is performed in a nitrogen-containing gas atmosphere comprising >80% by volume of nitrogen, based on a total gas atmosphere.

38. The process as recited in claim 33, wherein the at least one element is selected from a cobalt base alloy, a nickel base alloy, and an iron base alloy.

39. The process as recited in claim 38, wherein where the cobalt base alloy, the nickel base alloy, and the iron base alloy comprise at least one constituent selected from the group consisting of Si, Mo, Ti, Ta, Nb, V, S, C, P, Al, B, Y, W, Cu, Zn and Mn.

40. The process as recited in claim 33, wherein the nitriding is performed at a temperature >1000° C.

41. The process as recited in claim 33, wherein the nitriding is performed for a period of at least 1 hour.

42. The process as recited in claim 33, wherein the chromium is present in an amount of from 30 to 95 wt.-%, based on a total weight of the alloy powder.

43. The process as recited in claim 33, wherein the at least one element is present in an amount of from 15 to 70 wt.-%, based on a total weight of the alloy powder.

44. The process as recited in claim 33, wherein the alloy powder further comprises at least one additional element selected from the group consisting of V, Mo, Ta, Nb, Y, W and Mn in an amount of up to 20 wt.-%, based on a total weight of the alloy powder.

45. The process as recited in claim 33, further comprising:
producing a melt comprising,
at least 10 wt.-% of chromium, and
at least 10 wt.-% of at least one element selected from,
transition groups IIIA to IIB of the Periodic Table of Elements, and
B, Al, Si, Ti, Ga, C, Ge, P and S;
atomizing the melt so as to form an alloy powder; and
nitriding the alloy powder in the presence of nitrogen so as to from at least one of CrN and Cr₂N.

46. The process as recited in claim 45, wherein the atomizing breaks up the melt into small droplets, the atomization being performed by a gas jet or a water jet.

47. The process as recited in claim 46, wherein a gas of the gas jet comprises protective gases.

48. The process as recited in claim 47, wherein the protective gases are argon or nitrogen.

49. The process as recited in claim 45, wherein the melt has a temperature which is from 20 to 250° C. above a melting point of the alloy powder.

50. The process as recited in claim 45, wherein constituents of the melt or the alloy powder are at least partly provided in an elemental form or as a ferrous alloy.

51. The process as recited in claim 45, wherein a majority of sintering bridges produced during the nitriding between particles of the alloy powder are broken after the nitriding.

52. A chromium nitride-containing spraying powder obtainable by the process as recited in claim 33.

53. The chromium nitride-containing spraying powder as recited in claim 52, wherein the chromium nitride-containing spraying powder comprises at least one of CrN and Cr₂N as a hard material.

54. The chromium nitride-containing spraying powder as recited in claim 52, wherein the chromium nitride-containing spraying powder comprises chromium nitride precipitates having an average diameter of from 0.1 to 20 μm.

55. The chromium nitride-containing spraying powder as recited in claim 52, wherein the chromium nitride-containing spraying powder comprises CrN in an amount of at least 70 wt.-%, based on a total weight of the chromium nitride-containing spraying powder.

56. The chromium nitride-containing spraying powder as recited in claim 52, wherein the chromium nitride-containing spraying powder is substantially free of carbides and borides.

57. The chromium nitride-containing spraying powder as recited in claim 52, wherein the chromium nitride-containing spraying powder comprises homogeneously distributed chromium nitride precipitates.

58. The chromium nitride-containing spraying powder as recited in claim 52, wherein the chromium nitride-containing spraying powder is surrounded by a covering layer of chromium nitrides.

59. The chromium nitride-containing spraying powder as recited in claim 58, wherein the covering layer of chromium nitrides has an average layer thickness of from 1 to 8 μm.

60. The chromium nitride-containing spraying powder as recited in claim 52, wherein the chromium nitride-containing spraying powder comprises from 50 to 80 wt.-% of chromium nitrides, based on a total weight of the chromium nitride-containing spraying powder.

61. The chromium nitride-containing spraying powder as recited in claim 52, wherein the chromium nitride-containing spraying powder comprises up to 1 wt.-% of at least one of boron and sulfur, based on a total weight of the chromium nitride-containing spraying powder.

62. A spraying powder blend comprising the chromium nitride-containing spraying powder as recited in claim 52.

63. A process for producing a surface-coated component, the process comprising:
providing a component;
providing the chromium nitride-containing spraying powder as recited in claim 52 or a spraying powder blend comprising the chromium nitride-containing spraying powder as recited in claim 52; and
coating the component by thermally spraying the component with the chromium nitride-containing spraying powder or with the spraying powder blend.

64. The process as recited in claim 63, wherein the thermally spraying is a high-speed flame spraying or a plasma spraying.

65. A coated component obtainable by the process as recited in claim 63.

66. A method of using chromium nitride-containing spraying powder as recited in claim 52 or a spraying powder blend comprising the chromium nitride-containing spraying powder as recited in claim 52 to surface-coat a component, the method comprising:
providing a component;
providing the chromium nitride-containing spraying powder 52 or a spraying powder blend comprising the chromium nitride-containing spraying powder as recited in claim 52; and
using the chromium nitride-containing spraying powder or the spraying powder blend to surface-coat the component.

67. The method of using as recited in claim 66, wherein the surface coating is performed via as thermal spraying.

68. The method of using as recited in claim 67, wherein the thermal spraying is a high-speed flame spraying or a plasma spraying
